(19) United States
(12) Patent Application Publication
(10) Pub. No.: US 2003/0236876 A1
(43) Pub. Date: Dec. 25, 2003

(54) User selectable default alarm severity levels

(75) Inventors: Michael E. Curtin, Foothill Ranch, CA (US); Anthony Barrera, Chino Hills, CA (US); Charles Campbell Gorlinski JR., Santa Ana, CA (US)

Correspondence Address: Fogg Slifer Polglaze Leffert & Jay, P.A., P.O. Box 581009, Minneapolis, MN, 55458-1009, US

(73) Assignee: ADC DSL Systems, Inc.

(21) Appl. No.: 10/177,530

(22) Filed: Jun. 20, 2002

(51) Int. Cl. G06F 15/173

(52) U.S. Cl. 709/224; 340/691.1

(57) ABSTRACT

A user identification is input to a system. The system uses the user identification to select a set of default alarm severity levels. An indication of the selected set of default alarm severity levels is stored in memory. When a predetermined condition occurs in one of the system's function cards, the alarm that is generated is based on the selected default alarm severity level.

### TECHNICAL FIELD

The present invention relates generally to communications and particularly to the generation of faults in a communication system.

### BACKGROUND

Some electronic systems, especially communication systems, may be configured to generate alarms that indicate a malfunction or the occurrence of a certain condition in the system. For example, a T1 card in a data communication system may generate a minor error alarm when the T1 line going into the card experiences a certain bit error rate.

Some alarms require immediate attention while others, in certain systems, can be ignored or can wait until normal maintenance is performed. A system typically has a default level at which an alarm is ignored. These default levels are stored in the system when they are delivered to customers so that the customer is not bothered by alarms that do not require immediate attention.

A problem with having default alarm severity levels is that different customers may employ the same system in different applications. Therefore, one customer may require a different default alarm severity level than another customer.

One way to fix this problem is to have different software code that detects the different conditions and generates the appropriate level of alarm for a particular customer. However, this is very labor intensive to have to generate different code for each customer. There is a resulting need in the art for default alarm severity levels that are selectable by the customer or user.

### SUMMARY

Embodiments of the present invention encompass a method for user selection of default alarm severity levels in a system. A user identification is detected and used to select a first set of default alarm severity levels out of a plurality of default alarm severity level sets. An indication of the selected set of default alarm severity levels is stored.

In one embodiment, when a predetermined condition occurs in a system unit, a controller unit determines which alarm to generate based on the predetermined condition and the selected set of default alarm severity levels. The alarm is then indicated by an alarm processing unit or some other type of alarm indication device.

### BRIEF DESCRIPTION OF THE DRAWINGS

FIG. 1 shows a block diagram of one embodiment of an electronic system of the present invention.

FIG. 2 shows a block diagram of one embodiment of a controller unit in accordance with the electronic system of the present invention.

FIG. 3 shows a flowchart of one embodiment of a user selectable default alarm severity level method of the present invention.

FIG. 4 shows a flowchart of one embodiment of an alarm activation method of the present invention.

### DETAILED DESCRIPTION

Embodiments of the present invention provide a system with the capability to have multiple sets of default alarm severity levels that are customer/user selectable. A user inputs a user identification to identify the customer and the system uses, when an error condition occurs, the default alarm severity level assigned to that particular customer. In one embodiment, these default alarm severity levels are saved indefinitely regardless of any additionally user identification inputs.

The subsequent discussion of the embodiments of the present invention refers to sets of default alarm severity levels in a communication system. The present invention, however, is not limited to a communication system. Any electronic system that requires user selectability of default alarm severity levels can employ the embodiments of the present invention.

The embodiments of the present invention are also not limited to any quantity of alarm severity levels in each set of default alarm severity levels. Each set may be comprised of only one or more than one default alarm severity level.

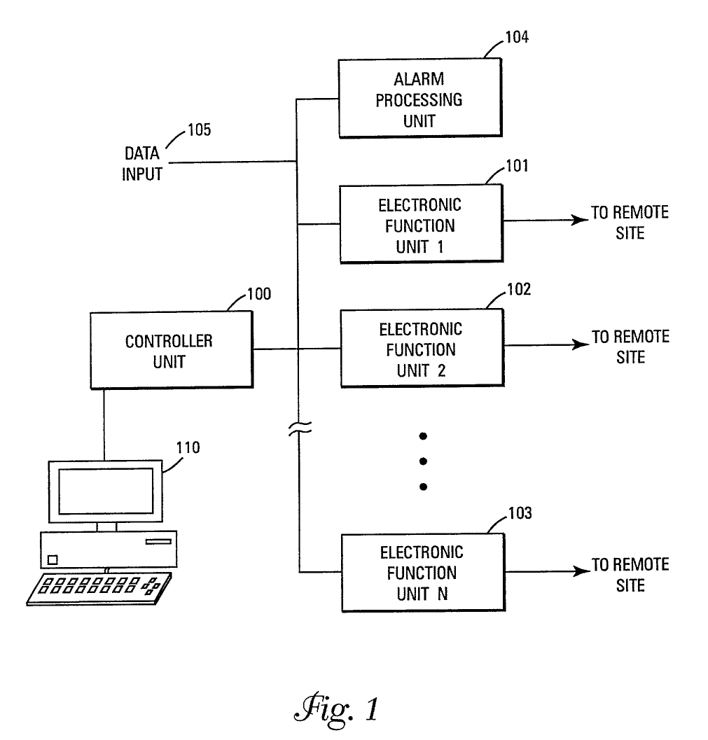

FIG. 1 illustrates a block diagram of one embodiment of an electronic system of the present invention. In one embodiment, the electronic system is a modem communication system that provides a data delivery service.

A system control unit (100) controls operation of the system. The control unit (100) incorporates the circuitry required to control and interface with the other units (101-104) of the system. The control unit (100) executes the various embodiments of the user selectable default alarm severity level method of the present invention.

Electronic function units (101-103) are coupled to the control unit (100). In one embodiment, the electronic function units (101-103) and the controller unit (100) are electrically connected through a card cage backplane that is well known in the art.

In one embodiment, the electronic function units (101-103) are communication devices. For example, the electronic function units (101-103) can be digital subscriber line modems. In another embodiment, electronic function unit 1 (101) is a T1 communication device, electronic function unit 2 (102) is a DSL modem, and electronic function unit N (103) is a DS3 modem.

The electronic function units (101-103) of FIG. 1 are for illustration purposes only. There is no limit to the quantity or functionality of the units (101-103). For example, if the electronic function units (101-103) are communication devices, they may comply with any data transfer protocol including T1, T3, or DSX.

If the electronic function units (101-103) are communication devices, a data input (105) can be supplied to the communication devices to be transformed to the appropriate data transfer protocol for transmission to a remote site. For example, the data input (105) is a DS3 line from a data source such as a data network. The data input (105) can then be coupled to one or more of the electronic function units (101-103) for transformation to another data transfer protocol (e.g., DS1) for transmission to a remote site.

In one embodiment, an alarm processing unit (104) is coupled to the other units (100-103) of the electronic system of FIG. 1. The alarm processing unit (104) is responsible for receiving and displaying alarm indications from the controller unit (100).

Any number and/or type of alarm severity level can be handled by the embodiments of the present invention. Some of the possible alarm severity levels are: not reported, event, minor, major, and critical. These alarm severity levels are for illustration purposes only. Other alarm severity levels are embodied by the present invention.

Alternate embodiments have different quantities of alarm severity levels. For example, if an embodiment uses an 8-bit word to represent possible alarm severity levels, such a word could represent 256 different levels.

The condition that requires a particular alarm activation varies depending on the type of electronic system. In the communication system embodiment described herein, the alarm activation conditions may include a loss of signal to one of the modems or a quality of service below a predetermined threshold in another modem. The present invention is not limited to any particular alarm activation conditions and/or errors.

When the controller unit (100) detects that one or more of the electronic function units (101-103) are experiencing an alarm activation condition (e.g., loss of signal), the controller unit (100) transmits the alarm severity level to the alarm processing unit. The alarm severity level depends on the predetermined condition and the default alarm severity level that has been selected based on the user identification.

In one embodiment, the alarm processing unit has multiple light emitting diodes (LEDs) that are each assigned to a different level of alarm. For example, the alarm severity level LEDs used by the alarm processing unit (104) include an event alarm, a minor alarm, a major alarm, and a critical alarm. Other embodiments assign LEDs to other alarm severity levels. Still other embodiments use other indicating devices, instead of LEDs, to indicate an alarm activation. For example, the alarm indicating devices may include incandescent lights, buzzers, and/or voice annunciation.

The present invention is not limited by the manner in which the type of alarm is transmitted to the alarm processing unit. The controller unit (100), in one embodiment, activates the appropriate relay that is connected to the indicating device that indicates the desired alarm condition. In another embodiment, the controller unit (100) transmits data over a serial or parallel bus to the alarm processing unit (104). The alarm processing unit (104) is then responsible for interpreting the data and activating the appropriate indicating device.

Another embodiment does not use the alarm processing unit (104). Such an embodiment may display the alarm conditions on a computer terminal (110) that is connected to the electronic system. The computer terminal (110) can receive, interpret, and display the information from the controller card (100) that indicates which type of alarm to display. The computer terminal (110) can then display on its monitor the alarm condition. In one embodiment, this display is a graphical user interface type display.

The computer terminal (110) may also have other functions beyond alarm indications. For example, the computer terminal (110) can communicate data with the electronic function units (101-103). The computer terminal (110) is also used by the customer/user to input a user identification.

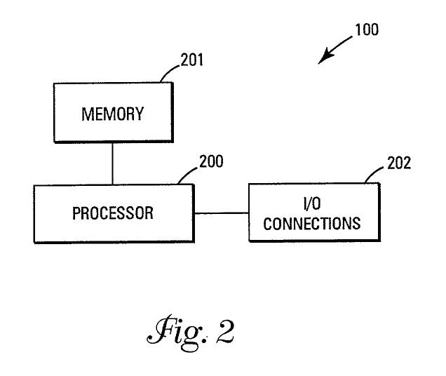

FIG. 2 illustrates a block diagram of one embodiment of a controller unit (100) in accordance with the electronic system of the present invention. This block diagram is for illustration purposes only and does not limit the embodiments of the present invention to any controller unit functionality.

The controller unit (100) has a processor (200) or some other type of controlling circuitry. The processor (200) may be a microprocessor or microcontroller. The processor (200) is responsible for executing the embodiments of the user selectable default alarm severity level method of the present invention.

The processor (200) is coupled to memory (201) that stores data for use by the processor (200). The memory (201) of the present invention includes both volatile and non-volatile memory. Volatile memory includes random access memory. Non-volatile memory includes battery-backed random access memory, or electrically erasable read only memory. The memory of the present invention may be any type of memory technology including semiconductor, magnetic, or optical.

In one embodiment, the memory (201) stores a flag or other indication that indicates another set of alarm defaults is to be used. If the user default alarm severity level indication is stored in non-volatile memory, the indication is not removed when the system is powered-down.

The controller unit (100) also includes input/output (I/O) connections (202) in order for the unit (100) to communicate with other electronic units and/or any other portion of the system. The I/O connections (202) include the backplane connector, if the unit is configured for installation in a card cage, or any other type of connector or system bus connection.

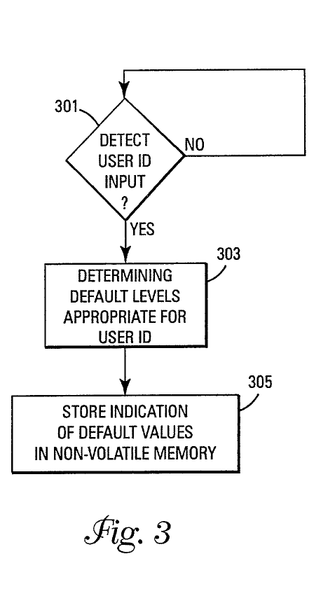

FIG. 3 illustrates a flowchart of one embodiment of a user selectable default alarm severity level method of the present invention. The system detects a user identification input by a user/customer (301). This user identification may be a combination of a user name, comprising alphanumeric characters, along with a password. In another embodiment, the user identification is only the password. In still another embodiment, only a user name is required.

One embodiment of the present invention authenticates the user name and/or password that was entered. This would be used to reduce the occurrence of unauthorized access.

If the proper user identification is entered, the system determines the set of alarm default levels appropriate for that particular user identification (303). If the embodiment only provides two different sets of default alarm severity levels, only a flag is required in memory to indicate to the controller to use an alternate set of default alarm severity levels.

In an alternate embodiment, the user identification is used to set other system configuration data. For example, complete T1 or DS3, STS1, and OC-3 provisioning parameter sets could be established using this login procedure. The default system configuration data may be set in addition to the default alarm severity levels or instead of the alarm severity levels.

If the embodiment provides more than two different sets of default alarm severity levels, the memory of the system may include a look-up table such that the controller finds the user identification in memory along with the required default levels (303). In an alternate embodiment, an address pointer generated from the user identification points to the set of default alarm severity levels.

The indication of the set of desired default alarm severity levels is then stored in memory (305). As described previously, the stored indication may be the flag indicating an alternate set of default alarm severity levels are to be used, the address pointer that points to the default alarm severity levels, or any other such indication.

In one embodiment, the default alarm severity levels are saved indefinitely regardless of any additionally user identification inputs. Alternate embodiments change the default alarm severity levels with different user identifications.

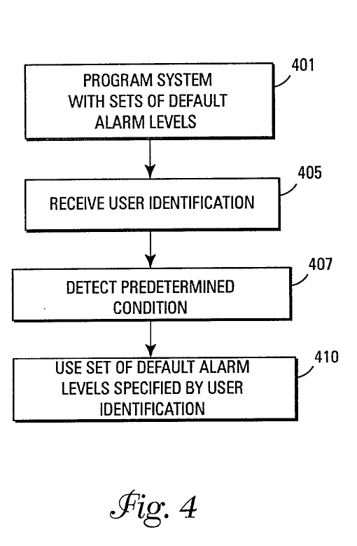

FIG. 4 illustrates a flowchart of one embodiment of an alarm activation method of the present invention. In order to illustrate this embodiment of operation, the electronic system is assumed to be a communication system that has a number of modem units. Each modem unit is capable of communicating with a remote modem unit using at least one communication standard (e.g., DS3).

The communication system in this scenario is manufactured and programmed with three different sets of default alarm severity levels (401). The first set assigns a loss of signal alarm as being a major alarm. When the loss of signal condition occurs, an LED is illuminated and a major alarm report is sent to the customer.

The second set of default alarm severity levels assigns the loss of signal as an event. When the loss of signal condition occurs, it is logged and a report is sent to the customer.

The third set of default alarm severity levels assigns the loss of signal as a not reported alarm. When the loss of signal condition occurs, nothing is done.

When the customer initializes the system, a user identification is input (405). The system uses this user identification to determine that that particular customer desires the third set of default alarm severity levels. This indication is stored in non-volatile memory. Now when a particular condition occurs (407), the alarm severity levels identified in the third set of default alarm severity levels are used (410).

The above-described scenario is for illustration purposes only. The quantity and functionality of the default alarm severity levels vary with the system, customer, as well as other factors.

Numerous modifications and variations of the present invention are possible in light of the above teachings. It is therefore to be understood that within the scope of the appended claims, the invention may be practiced otherwise than as specifically described herein.

What is claimed is:

1. A method for user selection of default alarm severity levels, the method comprising:
detecting receipt of a user identification;
selecting a first set of default alarm severity levels, from a plurality of sets of default alarm severity levels, in response to the user identification; and
storing an indication of the first set of default alarm severity levels.

2. The method of claim 1 wherein detecting input of a user identification comprises authenticating the user identification.

3. The method of claim 1 wherein storing the indication of the first set of default alarm severity levels comprises storing the indication in non-volatile memory.

4. The method of claim 1 wherein the system is a communication system comprising a plurality of modem units and a controller unit capable of generating an alarm in response to a predetermined condition experienced by at least one of the plurality of modem units.

5. The method of claim 1 wherein the user identification comprises a user name and password.

6. A method for user selection of default alarm severity levels in a communication system comprising a plurality of modem units and a controller unit, the method comprising:
detecting receipt of a user identification;
selecting a first set of default alarm severity levels, from a plurality of sets of default alarm severity levels, in response to the user identification; and
storing, in non-volatile memory, an indication of the first set of default alarm severity levels.

7. The method of claim 6 wherein a first modem unit of the plurality of modem units communicates using a DS3 standard.

8. The method of claim 6 wherein a first modem unit of the plurality of modem units communicates using a digital subscriber line standard.

9. The method of claim 6 and further including:
detecting a predetermined condition in a first modem unit of the plurality of modem units; and
responding to the predetermined condition with an alarm that is generated in response to the first set of default alarm severity levels.

10. A method for user selection of default alarm severity levels in a communication system comprising a plurality of modem units and a controller unit, the method comprising:
detecting receipt of a user identification;
selecting a first set of default alarm severity levels, from a plurality of sets of default alarm severity levels, in response to the user identification;
storing an indication of the first set of default alarm severity levels;
detecting a predetermined condition in a first modem unit of the plurality of modem units; and
responding to the predetermined condition with an alarm that is generated in response to the first set of default alarm severity levels.

11. The method of claim 10 wherein the indication of the first set of default alarm severity levels is a flag that indicates either the first set of default alarm severity levels or a second set of alarm default levels.

12. The method of claim 10 wherein the predetermined condition is a loss of signal.

13. The method of claim 10 wherein the alarm is generated by an alarm processing unit that is coupled to the controller unit.

14. An electronic system comprising:
a plurality of electronic function units; and
a controller unit, coupled to the electronic function units, capable of selecting a first set of default alarm severity levels of a plurality of sets of default alarm severity levels in response to a user identification and storing an indication of the first set of default alarm severity levels.

15. The system of claim 14 wherein the electronic system is a communication system and the plurality of electronic function units are modem units that are each capable of communicating with a remote unit using a communication protocol.

16. The system of claim 14 wherein the controller unit is further capable of generating an alarm in response to the first set of default alarm severity levels and a predetermined condition experienced by a first electronic function unit.

17. A communication system comprising:
a plurality of modem units that are each capable of communicating using at least one data transfer protocol;
an alarm processing unit having at least one alarm indication device; and
a controller unit, coupled to the modem units and the alarm processing unit, capable of selecting a first set of default alarm severity levels of a plurality of default alarm severity level sets in response to a user identification, the controller unit further capable of generating an alarm with the at least one alarm indication device in response to a predetermined condition of at least one of the plurality of modem units and the first set of default alarm severity levels.

18. The system of claim 17 wherein the at least one indication device includes light emitting diodes.

19. A controller unit comprising:
memory that stores data for use by the controller unit;
an input/output connection that provides access to and from the controller unit; and
a processor coupled to the memory and the input/output connection, the processor capable of receiving a user identification, selecting a first set of default alarm severity levels from a plurality of default alarm severity level sets, and storing an indication of the first set of default alarm severity levels in memory.

20. The controller unit of claim 19 and further including a modem unit coupled to the processor such that the processor is able to detect an occurrence of a predetermined condition and generate an alarm based on the indication of the first set of default alarm severity levels.

21. A method for user selection of default system configuration data, the method comprising:
detecting receipt of a user identification;
selecting a first set of default system configuration data, from a plurality of sets of default system configuration data, in response to the user identification; and
storing an indication of the first set of default system configuration data.
